(19) United States
(12) Patent Application Publication
(10) Pub. No.: US 2022/0034580 A1
(43) Pub. Date: Feb. 3, 2022

(54) Portable Refrigerator Assembly

(71) Applicants: Bernard Smith, Kingshill, VI (US); Angela Smith, Kingshill, VI (US)

(72) Inventors: Bernard Smith, Kingshill, VI (US); Angela Smith, Kingshill, VI (US)

(21) Appl. No.: 16/942,349

(22) Filed: Jul. 29, 2020

(51) Int. Cl. F25D 23/12; F25D 11/00; F25D 25/02; A47J 36/24

(52) U.S. Cl. CPC F25D 23/12; F25D 11/00; F25D 2400/12; A47J 36/2483; F25D 2400/02; F25D 25/025

(57) ABSTRACT

A portable refrigerator assembly includes a refrigerator that has a box and a door that is hingedly coupled to the box. A plurality of feet is each coupled to and extends laterally away from the refrigerator for stabilizing the refrigerator on a support surface. A cooling unit is provided and the cooling unit is positioned in the refrigerator such that the cooling unit is in thermal communication with an interior of the refrigerator. In this way the cooling unit can cool the interior of the refrigerator. A pair of warming plates is each coupled to the refrigerator and a food item can be positioned on each of the warming plates. Additionally, each of the warming plates generates heat when the warming plates are turned on to warm the food item.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to refrigerator devices and more particularly pertains to a new refrigerator device for cooling or warming food items in a remote location.

### (2) Description of Related Art Including Information Disclosed Under 37 CFR 1.97 and 1.98

The prior art relates to refrigerator devices including a cooler that has a heat exchanger integrated therein which can be fluidly coupled to an air conditioning system of a vehicle for cooling the cooler. The prior art discloses a portable cooling and warming box that has a cooling unit and a warming unit each integrated into an interior of the cooling and warming box. The prior art discloses a cooler that includes a thermoelectric cooling device and a thermoelectric heating device. The prior art discloses a refrigerator that has thermoelectric heating and cooling devices and which has air channels integrated therein for evenly distributing air throughout the refrigerator. The prior art also discloses a modular travel bag that includes a toaster and a hot plate.

### BRIEF SUMMARY OF THE INVENTION

An embodiment of the disclosure meets the needs presented above by generally comprising a refrigerator that has a box and a door that is hingedly coupled to the box. A plurality of feet is each coupled to and extends laterally away from the refrigerator for stabilizing the refrigerator on a support surface. A cooling unit is provided and the cooling unit is positioned in the refrigerator such that the cooling unit is in thermal communication with an interior of the refrigerator. In this way the cooling unit can cool the interior of the refrigerator. A pair of warming plates is each coupled to the refrigerator and a food item can be positioned on each of the warming plates. Additionally, each of the warming plates generates heat when the warming plates are turned on to warm the food item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a portable refrigerator assembly according to an embodiment of the disclosure.

FIG. 2 is a front view of an embodiment of the disclosure.

FIG. 3 is a back view of an embodiment of the disclosure.

FIG. 4 is a left side phantom view of an embodiment of the disclosure.

FIG. 5 is a top view of an embodiment of the disclosure.

FIG. 6 is a front perspective view of an embodiment of the disclosure.

FIG. 7 is a front view of an interior of a refrigerator of an embodiment of the disclosure.

### DETAILED DESCRIPTION OF THE INVENTION

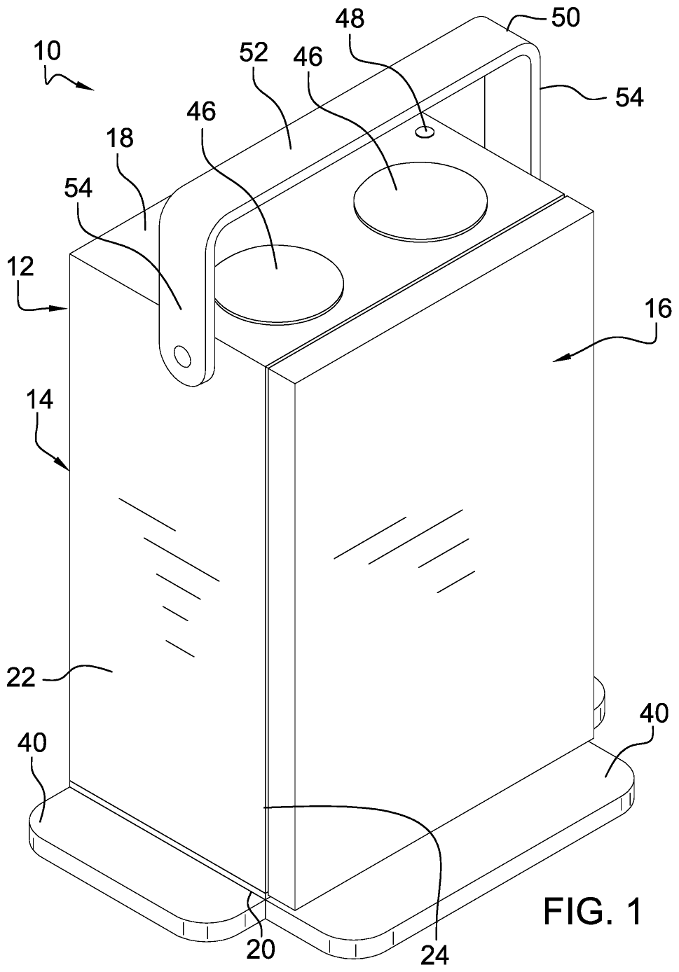

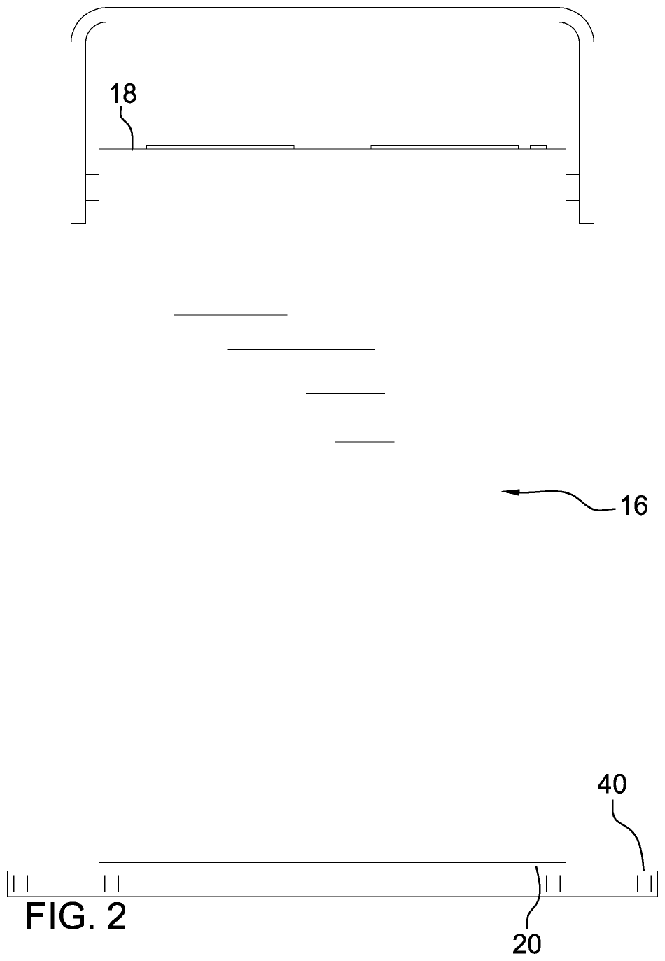

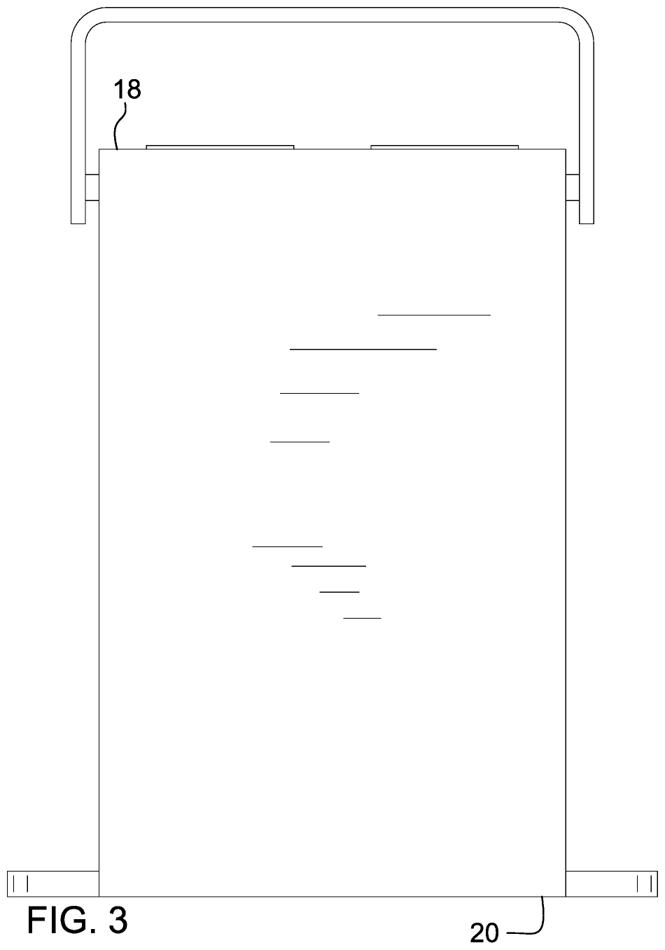

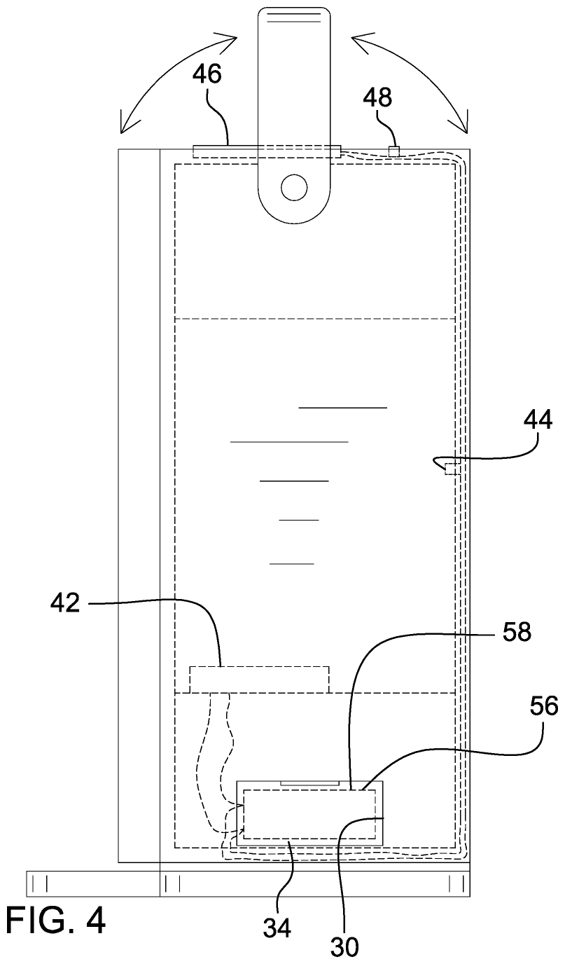

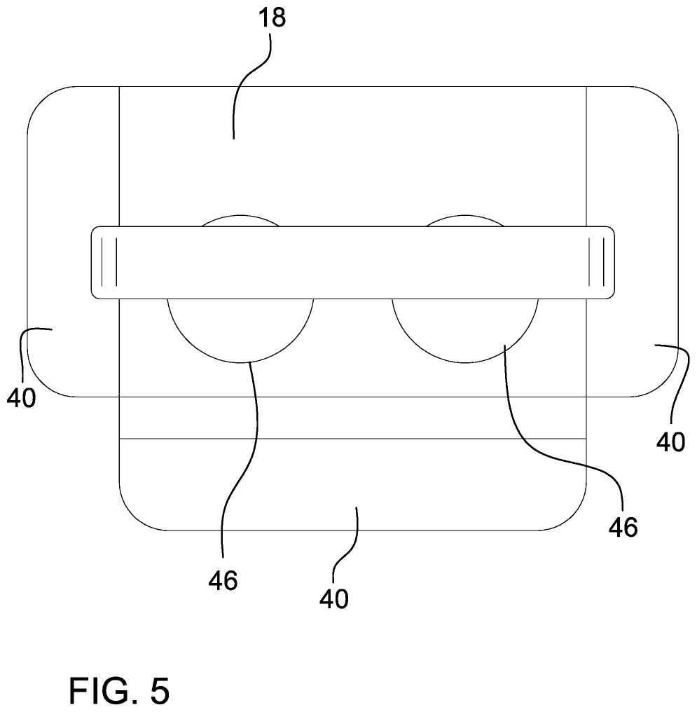

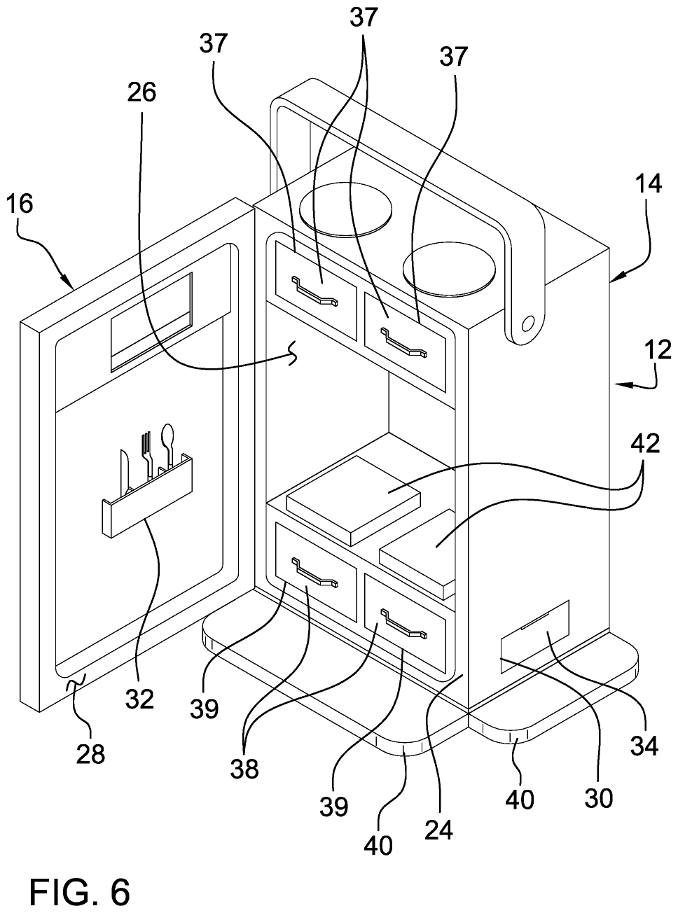

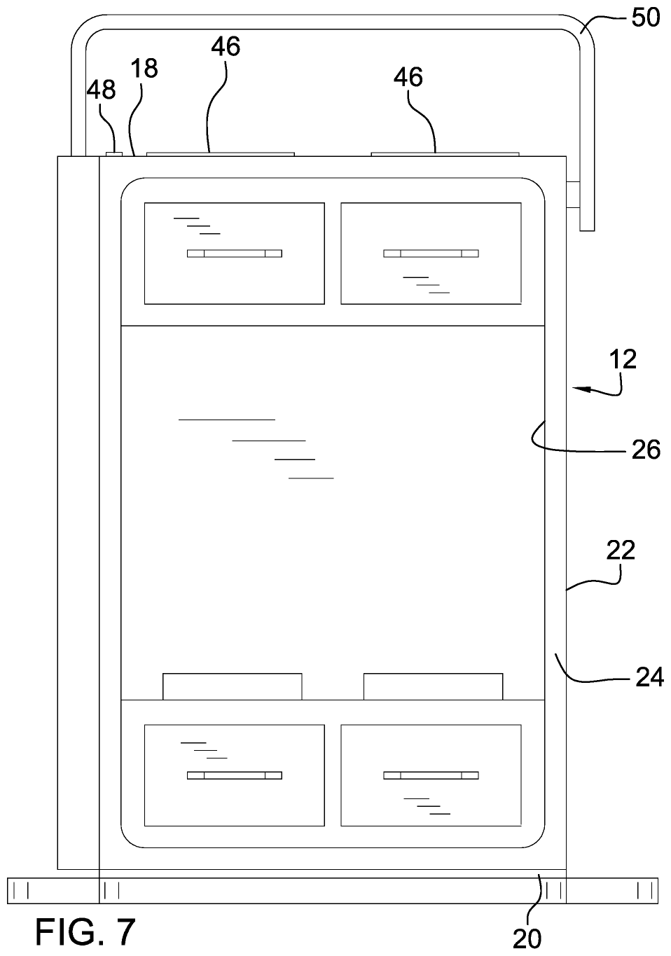

With reference now to the drawings, and in particular to FIGS. 1 through 7 thereof, a new refrigerator device embodying the principles and concepts of an embodiment of the disclosure and generally designated by the reference numeral 10 will be described.

As best illustrated in FIGS. 1 through 7, the portable refrigerator assembly 10 generally comprises a refrigerator 12 has a box 14 and a door 16 that is hingedly coupled to the box 14. The refrigerator 12 is comprised of a thermally insulating material to retain food items at a preferred temperature. The refrigerator 12 may have a maximum height of approximately 36.0 inches thereby facilitating the refrigerator 12 to be carried by an individual. The box 14 has a top wall 18, a bottom wall 20 and an outer wall 22 extending therebetween. The outer wall 22 has a front side 24, the front side 24 is open into an interior of the box 14 and the outer wall 22 has an inside surface 26. The door 16 has a rear surface 28 and the rear surface 28 abuts the front side 24 of the outer wall 22 when the door 16 is closed. Additionally, the outer wall 22 has a battery opening 30 extending therethrough. A shelf 32 is coupled to the rear surface 28 of the door 16 for storing utensils.

A battery door 34 is hingedly coupled to the outer wall 22 of the refrigerator 12. The battery door 34 closes the battery opening 30 when the battery door 34 is closed. Additionally, the battery door 34 exposes the battery opening 30 when the battery door 34 is opened. A pair of first drawers 36 is each slidably integrated into a respective first drawer slot 37 in the interior of the box 14 to store food items. Each of the first drawers 36 is positioned adjacent to the top wall 18. A pair of second drawers 38 is each slidably integrated a respective second drawer slot 39 in the interior of the box 14 to store food items. Each of the second drawers 38 is positioned adjacent to the bottom wall 20.

A plurality of feet 40 is each coupled to and extends laterally away from the refrigerator 12 for stabilizing the refrigerator 12 on a support surface. Each of the feet 40 extends laterally away from the outer wall 22 and each of the feet 40 is aligned with the bottom wall 20 of the refrigerator 12. A cooling unit 42 is positioned in the refrigerator 12 such that the cooling unit 42 is in thermal communication with an interior of the refrigerator 12. In this way the cooling unit 42 cools the interior of the refrigerator 12. Additionally, the cooling unit 42 comprises a thermoelectric cooling plate. A cooling switch 44 is movably coupled to the refrigerator 12. The cooling switch 44 is electrically coupled to the cooling unit 42 and the cooling switch 44 turns the cooling unit 42 on and off.

A pair of warming plates 46 is each coupled to the refrigerator 12 to have a food item positioned thereon. Each of the warming plates 46 generates heat when the warming plates 46 are turned on to warm the food item. Additionally, each of the warming plates 46 is positioned on the top side of the outer wall 22 of the refrigerator 12 and each of the warming plates 46 is positioned outside of the refrigerator 12. Each of the warming plates 46 may comprise electronic warming plates with an operational temperature ranging between approximately 100.0 degrees Fahrenheit and 120.0 degrees Fahrenheit. A warming switch 48 is movably coupled to the refrigerator 12. The warming switch 48 is electrically coupled to each of the warming plates 46 and the warming switch 48 turns the warming plates 46 on and off.

A handle 50 is pivotally coupled to the refrigerator 12 to facilitate the refrigerator 12 to be carried. The handle 50 has a central member 52 extending between a pair of end members 54. Each of the end members 54 is pivotally coupled to the outer wall 22 of the refrigerator 12 having the central member 52 being spaced from the top side of the outer wall 22. A power supply 56 is positioned in the refrigerator 12 and the power supply 56 is electrically coupled to each of the warming plates 46 and the cooling unit 42. The power supply 56 comprises at least one battery 58, and the battery 58 is aligned with the battery opening 30 in the outer wall 22 of the refrigerator 12.

In use, the food items are stored in each of the first drawers 36, the second drawers 38 and the interior of the refrigerator 12. The cooling switch 44 is turned on to cool the interior of the refrigerator 12 and the handle 50 is gripped to carry the refrigerator 12. In this way the food items can be transported and stored in a remote location. The warming plates 46 can be turned on for warming food items that are positioned thereon. Additionally, utensils, such as forks and spoons, can be stored in the shelf 32 on the door 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable refrigerator assembly having warming plates integrated therein for either cooling or warming food items, said assembly comprising:
a refrigerator having a box and a door being hingedly coupled to said box, said refrigerator being comprised of a thermally insulating material wherein said refrigerator is configured to retain food items at a preferred temperature;
a plurality of feet, each of said feet being coupled to and extending laterally away from said refrigerator for stabilizing said refrigerator on a support surface, each of said feet extending laterally away from said outer wall, each of said feet being aligned with said bottom wall of said refrigerator;
a cooling unit being positioned in said refrigerator such that said cooling unit is in thermal communication with an interior of said refrigerator wherein said cooling unit is configured to cool the interior of said refrigerator, said cooling unit comprising a thermoelectric cooling plate; and
a pair of warming plates, each of said warming plates being coupled to said refrigerator wherein each of said warming plates is configured to have a food item positioned thereon, each of said warming plates generating heat when said warming plates are turned on wherein each of said warming plates is configured to warm the food item.

2. The assembly according to claim 1, wherein said box has a top wall, a bottom wall and an outer wall extending therebetween, said outer wall having a front side, said front side being open into an interior of said box, said outer wall having an inside surface, said door having a rear surface, said rear surface abutting said front side of said outer wall when said door is closed, said outer wall having a battery opening extending therethrough.

3. The assembly according to claim 2, further comprising a shelf being coupled to said rear surface of said door wherein said shelf is configured to store utensils.

4. The assembly according to claim 2, further comprising a battery door being hingedly coupled to said outer wall of said refrigerator, said battery door closing said battery opening when said battery door is closed, said battery door exposing said battery opening when said battery door is opened.

5. The assembly according to claim 2, further comprising a pair of first drawers, each of said first drawers being slidably integrated into said interior of said box wherein each of said first drawers is configured to store food items, each of said first drawers being positioned adjacent to said top wall.

6. The assembly according to claim 5, further comprising a pair of second drawers, each of said second drawers being slidably integrated into said interior of said box wherein each of said second drawers is configured to store food items, each of said second drawers being positioned adjacent to said bottom wall.

7. The assembly according to claim 1, further comprising a cooling switch being movably coupled to said refrigerator, said cooling switch being electrically coupled to said cooling unit, said cooling switch turning said cooling unit on and off.

8. The assembly according to claim 2, wherein each of said warming plates being positioned on said top side of said outer wall of said refrigerator having each of said warming plates being positioned outside of said refrigerator.

9. The assembly according to claim 8, further comprising a warming switch being movably coupled to said refrigerator, said warming switch being electrically coupled to each of said warming plates, said warming switch turning said warming plates on and off.

10. The assembly according to claim 2, further comprising a handle being pivotally coupled to said refrigerator to facilitate said refrigerator to be carried, said handle having a central member extending between a pair of end members, each of said end members being pivotally coupled to said outer wall of said refrigerator having said central member being spaced from said top side of said outer wall.

11. The assembly according to claim 2, further comprising a power supply being positioned in said refrigerator, said power supply being electrically coupled to each of said warming plates and said cooling unit, said power supply comprising at least one battery, said battery being aligned with said battery opening in said outer wall of said refrigerator.

12. A portable refrigerator assembly having warming plates integrated therein for either cooling or warming food items, said assembly comprising:
a refrigerator having a box and a door being hingedly coupled to said box, said refrigerator being comprised of a thermally insulating material wherein said refrigerator is configured to retain food items at a preferred temperature, said box having a top wall, a bottom wall and an outer wall extending therebetween, said outer wall having a front side, said front side being open into an interior of said box, said outer wall having an inside surface, said door having a rear surface, said rear surface abutting said front side of said outer wall when said door is closed, said outer wall having a battery opening extending therethrough;
a shelf being coupled to said rear surface of said door wherein said shelf is configured to store utensils;
a battery door being hingedly coupled to said outer wall of said refrigerator, said battery door closing said battery opening when said battery door is closed, said battery door exposing said battery opening when said battery door is opened;
a pair of first drawers, each of said first drawers being slidably integrated into said interior of said box wherein each of said first drawers is configured to store food items, each of said first drawers being positioned adjacent to said top wall;
a pair of second drawers, each of said second drawers being slidably integrated into said interior of said box wherein each of said second drawers is configured to store food items, each of said second drawers being positioned adjacent to said bottom wall;
a plurality of feet, each of said feet being coupled to and extending laterally away from said refrigerator for stabilizing said refrigerator on a support surface, each of said feet extending laterally away from said outer wall, each of said feet being aligned with said bottom wall of said refrigerator;
a cooling unit being positioned in said refrigerator such that said cooling unit is in thermal communication with an interior of said refrigerator wherein said cooling unit is configured to cool the interior of said refrigerator, said cooling unit comprising a thermoelectric cooling plate;
a cooling switch being movably coupled to said refrigerator, said cooling switch being electrically coupled to said cooling unit, said cooling switch turning said cooling unit on and off;
a pair of warming plates, each of said warming plates being coupled to said refrigerator wherein each of said warming plates is configured to have a food item positioned thereon, each of said warming plates generating heat when said warming plates are turned on wherein each of said warming plates is configured to warm the food item, each of said warming plates being positioned on said top side of said outer wall of said refrigerator having each of said warming plates being positioned outside of said refrigerator;
a warming switch being movably coupled to said refrigerator, said warming switch being electrically coupled to each of said warming plates, said warming switch turning said warming plates on and off;
a handle being pivotally coupled to said refrigerator to facilitate said refrigerator to be carried, said handle having a central member extending between a pair of end members, each of said end members being pivotally coupled to said outer wall of said refrigerator having said central member being spaced from said top side of said outer wall; and
a power supply being positioned in said refrigerator, said power supply being electrically coupled to each of said warming plates and said cooling unit, said power supply comprising at least one battery, said battery being aligned with said battery opening in said outer wall of said refrigerator.
